(19) United States
(12) Patent Application Publication
(10) Pub. No.: US 2026/0247428 A1
(43) Pub. Date: Aug. 20, 2026

(54) METHOD FOR PERFORMING PREEMPTION MANAGEMENT IN WIRELESS COMMUNICATION SYSTEM, AND ASSOCIATED APPARATUS

(71) Applicant: MEDIATEK INC., Hsin-chu (TW)

(72) Inventors: Chien-Fang Hsu, Hsinchu City (TW); Hao-Hua Kang, Hsinchu City (TW); Hung-Tao Hsieh, Hsinchu City (TW); Chih-Chun Kuo, Hsinchu City (TW)

(73) Assignee: MEDIATEK INC., Hsin-chu (TW)

(21) Appl. No.: 19/474,721

(22) PCT Filed: May 24, 2024
(86) PCT No.: PCT/CN2024/095064

§ 371 Date: Oct. 12, 2025

Related U.S. Application Data
(60) Provisional application No. 63/504,468, filed on May 26, 2023.

(51) Int. Cl. H04W 72/566

(52) U.S. Cl. CPC H04W 72/566

(57) ABSTRACT

A method for performing preemption management in a wireless communication system and associated apparatus are provided, where a non-access-point station (non-AP STA) device is wirelessly linking to a first access point (AP) device. The method may include: performing, by the first AP device, a preemption client indication in at least one transmission behavior at beginning of a transmission period, for indicating that the non-AP STA device is a preemption client which should keep awake in a preemption period within the transmission period; wherein the preemption period is reserved for latency sensitive traffic transmission to the non-AP STA device.

### CROSS REFERENCE TO RELATED APPLICATION

This application claims the benefit of U.S. Provisional Application No. 63/504,468, filed on May 26, 2023. The content of the application is incorporated herein by reference.

### BACKGROUND OF THE INVENTION

### 1. Field of the Invention

The present invention is related to communication control, and more particularly, to a method for performing preemption management in a wireless communication system, and associated apparatus such as a wireless transceiver device (e.g., an access point (AP) device or a station (STA) device) in the wireless communication system.

### 2. Description of the Prior Art

According to the related art, an AP device may be arranged to transmit various data to one or more STA devices. When the latency sensitive traffic arrives in a medium access control (MAC) circuit of the AP device, a physical layer (PHY) circuit of the AP device may be transmitting a PHY protocol data unit (PPDU) which may occupy several milliseconds (ms), and until the PPDU transmission is finished, the PHY circuit typically needs to perform another enhanced distributed channel access (EDCA) process to get the channel access for the latency sensitive traffic, causing more latency to be introduced. Some suggestions may be proposed in the related art to try correcting the problem, but there may be further problems such as some side effects. Thus, a novel method and associated architecture are needed for solving the problems without introducing any side effect or in a way that is less likely to introduce a side effect.

### SUMMARY OF THE INVENTION

It is an objective of the present invention to provide a method for performing preemption management in a wireless communication system, and associated apparatus such as wireless transceiver devices (e.g., one or more AP devices and one or more non-access-point (non-AP) STA devices) in the wireless communication system, in order to solve the above-mentioned problems.

At least one embodiment of the present invention provides a method for performing preemption management in a wireless communication system, where a non-AP STA device is wirelessly linking to a first AP device. The method may comprise: performing, by the first AP device, a preemption client indication in at least one transmission behavior at beginning of a transmission period, for indicating that the non-AP STA device is a preemption client which should keep awake in a preemption period within the transmission period, where the preemption period may be reserved for latency sensitive traffic transmission to the non-AP STA device. For example, in response to receiving the preemption client indication, the non-AP STA device may be arranged to keep awake in the preemption period and be prepared for any downlink (DL) traffic or any uplink (UL) trigger. According to some embodiments, the preemption client indication may comprise a candidate preemption client list for recording at least one candidate preemption client suitable for the latency sensitive traffic transmission, where the aforementioned at least one candidate preemption client may comprise the non-AP STA device. In addition, the preemption management is applicable to any level among a transmission opportunity (TXOP) level and a PPDU level, for enhancing overall performance.

At least one embodiment of the present invention provides an AP device for performing preemption management in a wireless communication system such as that mentioned above, where the AP device may be one of multiple devices within the wireless communication system. The AP device may comprise a processing circuit that is arranged to control operations of the AP device. The AP device may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the AP device. For example, a non-AP STA device among the aforementioned at least one other device is wirelessly linking to the AP device. In addition, the AP device may be arranged to perform a preemption client indication in at least one transmission behavior at beginning of a transmission period, for indicating that the non-AP STA device is a preemption client which should keep awake in a preemption period within the transmission period, where the preemption period may be reserved for latency sensitive traffic transmission to the non-AP STA device.

At least one embodiment of the present invention provides a non-AP STA device for performing preemption management in a wireless communication system such as that mentioned above, where the non-AP STA device may be one of multiple devices within the wireless communication system. The non-AP STA device may comprise a processing circuit that is arranged to control operations of the non-AP STA device. The non-AP STA device may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the non-AP STA device. For example, the non-AP STA device is wirelessly linking to a first AP device among the aforementioned at least one other device. In addition, the non-AP STA device may be arranged to receive a preemption client indication in at least one transmission behavior at beginning of a transmission period, for indicating that the non-AP STA device is a preemption client which should keep awake in a preemption period within the transmission period, where the preemption period may be reserved for latency sensitive traffic transmission to the non-AP STA device; and in response to receiving the preemption client indication, the non-AP STA device may be arranged to keep awake in the preemption period and be prepared for any DL traffic or any UL trigger.

It is an advantage of the present invention that, through proper design, the method of the present invention, as well as the associated apparatus such as the wireless transceiver devices (e.g., the one or more AP devices and the one or more non-AP STA devices) in the wireless communication system, can perform communication operations with aid of preemption in an efficient manner, and more particularly, use the preemption client indication carrying the candidate preemption client list to inform all candidate preemption client(s) in the candidate preemption client list that they should keep awake during the preemption period, in order to enhance the overall performance. In addition, the method of the present invention and the associated apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates, in multiple sub-diagrams (a), (b) and (c) thereof, multiple DL PPDU types involved with a PPDU preemption control scheme according to an embodiment of the present invention.

FIG. 3 illustrates a target client control scheme of a method for performing preemption management in a wireless communication system according to an embodiment of the present invention.

FIG. 4 illustrates a PPDU-level control scheme of the method according to an embodiment of the present invention.

FIG. 5 illustrates the PPDU-level control scheme of the method according to another embodiment of the present invention.

FIG. 6 illustrates the PPDU-level control scheme of the method according to yet another embodiment of the present invention.

FIG. 7 illustrates a TXOP-level control scheme of the method according to an embodiment of the present invention.

FIG. 8 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

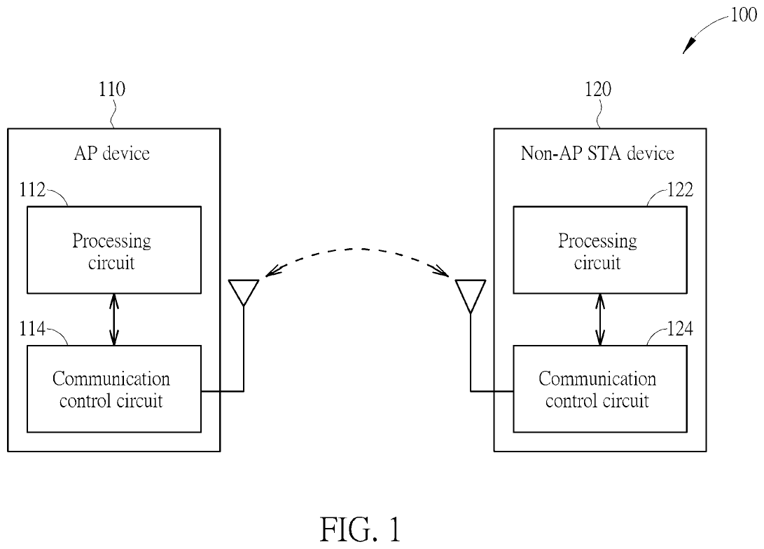

FIG. 1 is a diagram of a wireless communication system 100 according to an embodiment of the present invention. For better comprehension, the wireless communication system 100, as well as any wireless transceiver device #m among multiple wireless transceiver devices #1 . . . and #M therein, may be compatible or backward-compatible to one or more versions of the Institute of Electrical and Electronics Engineers (IEEE) 802.11 standards, but the present invention is not limited thereto. Regarding the multiple wireless transceiver devices #1 . . . and #M within the wireless communication system 100, a wireless transceiver device among them may be implemented as an AP device 110, and another transceiver device among them may be implemented as a non-AP STA device 120, but the present invention is not limited thereto. For example, two or more wireless transceiver devices among the multiple wireless transceiver devices #1 . . . and #M may be implemented as multiple AP devices {110}. In some examples, two or more wireless transceiver devices among the multiple wireless transceiver devices #1 . . . and #M may be implemented as multiple AP devices {110}, and/or two or more other wireless transceiver devices among the multiple wireless transceiver devices #1 . . . and #M may be implemented as multiple non-AP STA devices {120}.

As shown in FIG. 1, the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the non-AP STA device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 1, the processing circuit 112 can be arranged to control operations of the AP device 110, and the communication control circuit 114 can be arranged to perform communication control, and more particularly, perform wireless communication operations with the network (or at least one other device therein such as the non-AP STA device 120) for the AP device 110. In addition, the processing circuit 122 can be arranged to control operations of the non-AP STA device 120, and the communication control circuit 124 can be arranged to perform communication control, and more particularly, perform wireless communication operations with the network (or at least one other device therein such as the AP device 110) for the non-AP STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP STA device 120 may include, but are not limited to: a multifunctional mobile phone, a laptop computer, an all-in-one computer and a wearable device.

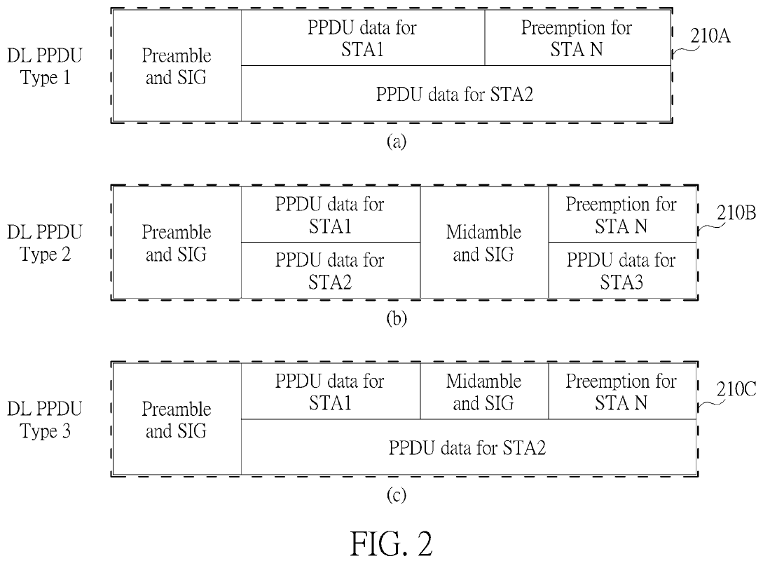

FIG. 2 illustrates, in multiple sub-diagrams (a), (b) and (c) thereof, multiple DL PPDU types involved with a PPDU preemption control scheme according to an embodiment of the present invention, where the PPDUs 210A, 210B and 210C may belong to the DL PPDU Type 1, the DL PPDU Type 2 and the DL PPDU Type 3, respectively. For better comprehension, assume that one or more functions of the wireless communication system 100 may be temporarily disabled to allow the AP device 110 and the non-AP STA device 120 to operate according to the PPDU preemption control scheme, but the present invention is not limited thereto. Based on the PPDU preemption control scheme, the wireless transceiver device #m such as the AP device 110 may perform preemption to pre-allocate certain section(s) of a PPDU (e.g., the PPDU 210A shown in the sub-diagram (a) of FIG. 2), especially a long PPDU, so that if any latency sensitive traffic such as low latency data for a target STA device (e.g. the non-AP STA device 120) comes, the pre-allocated resources can be used for transmission. However, if there is no such traffic coming before the preemption period, the pre-allocated resource may be wasted. Taking the PPDU 210A as an example of the PPDU, the PPDU data part(s) can be implemented in a resource unit (RU) form, and for multiple users, MIMO (or “multiple input, multiple output”) can be used, in order to multiply the radio link capacity using multiple transmission and receiving antennas. More particularly, a time axis may be illustrated along the horizontal direction to indicate that there are multiple fields with respect to time, and different parts illustrated along the vertical direction may correspond to different RUs, but the present invention is not limited thereto.

In addition, the target STA device may be implemented as a STA STA(N), which may be referred to as the “STA N” for brevity, and other STA devices may be implemented as STAs STA(1), STA(2), etc., which may be referred to as the STAs STA1, STA2, etc. for brevity.

Based on the PPDU preemption control scheme, there may be several possibilities to design the preemption part of the PPDU. For example, the PPDU data can be single user (SU) only. Regarding the PPDU 210A shown in the sub-diagram (a), the multiple fields may comprise the field(s) “Preamble and SIG” such as the fields/subfields of the Preamble as well as the SIGNAL (SIG) fields/subfields thereof, and further comprise data fields for the STAs STA1 and STA2 and a preemption field for the STA N (respectively labeled “PPDU data for STA1”, “PPDU data for STA2” and “Preemption for STA N” for better comprehension). Regarding the PPDUs 210B and 210C respectively shown in the sub-diagrams (b) and (c), the multiple fields may further comprise the field(s) “Midamble and SIG” such as the fields/subfields of the Midamble as well as the SIGNAL (SIG) fields/subfields thereof, and more particularly, comprise the data field for the STA STA3 (labeled “PPDU data for STA3” for better comprehension) when there is a need. The SIG in the Midamble and SIG may be optional if the Preamble and SIG has provided enough information for the STA N to decode the data portion in the preemption. There could be multiple Midamble and SIG instances and the Midamble and SIG may carry an indication indicating that if it is the last Midamble and SIG. For example, this indication may be implemented by way of a More Midamble bit (e.g., the More Midamble bit More_Midamble). When the More Midamble bit is equal to a first predetermined value (e.g., More_Midamble=1), this may indicate that there is at least one more Midamble and SIG following up in this PPDU. When the More Midamble bit is equal to another predetermined value (e.g., More_Midamble=0), this may indicate that the current Midamble and SIG is the last one of this PPDU. In addition, if the More Midamble bit is equal to the first predetermined value (e.g., More_Midamble=1), the Midamble and SIG carrying the bit can act in the same manner as the Preamble and SIG to provide signaling of following parts of the PPDU. In any case among the two cases of the sub-diagrams (b) and (c), if the Midamble and SIG still carry potential preemption for the STA N during the preemption, the STA N may keep waiting and being awake; otherwise, the STA N can go to and/or enter a power save (PS) mode (or a PS state).

For example, when the AP device 110 starts transmitting the PPDU 210A, the STA N needs to track the PPDU data for STA1 until the preemption portion. If there is no data for the STA N coming before the preemption, the preemption (or the RU(s) thereof) is wasted. When the AP device 110 starts transmitting the PPDU 210B, the STA N can wait until the Midamble and check the Midamble and SIG for following resource allocation. The Midamble typically consumes some resources but provides flexibility to rearrange the resources. If there is no data for the STA N coming before the preemption, the resource can be reallocated. When the AP device 110 starts transmitting the PPDU 210C, the STA N can wait until the Midamble and check the Midamble and SIG for following resource allocation. The Midamble typically consumes some resources but provides flexibility to rearrange the resources. As shown in the sub-diagram (c), the Midamble occupies only partial bandwidth of the PPDU. If there is no data for the STA N coming before the preemption, the resource can be reallocated. In addition, the Midamble contents may comprise the short training field (STF) and the long training field (LTF) for receivers to do synchronization and channel estimation, and the SIG contents may comprise the association identifier (IDs) (or “the AIDs”) of the STAs arranged to have RU(s) allocated for DL transmission, the RU allocation and channel bandwidth information, the PPDU length information, the allowed actions during the PPDU such as spatial reuse (SR), and other transmission (TX) vector (or TXVECTOR) and reception (RX) vector (or RXVECTOR) information, as well as the basic service set (BSS) color.

The AP device 110 operating according to the PPDU preemption control scheme may provide the clients' AIDs in the SIG so that if a target client (e.g., the STA N) is not listed in the SIG, the target client can enter the PS mode, and therefore, skips the PPDU (e.g., the PPDU with the preemption part thereof carrying the data for the target client). More particularly, the target client may not be ready to receive the data due to power saving or other reasons. For example, the target client such as the STA N may enter the PS mode after decoding the SIG, causing the STA N to become unable to receive the data for the STA N that is carried in the PPDU. The AP device 110 can operate according to at least one control scheme (e.g., one or more control schemes) of a method for performing preemption management in a wireless communication system, to make the target client be ready for receiving the data and to keep the power save (PS) mechanism still working without hindering any implementation regarding the PS mode, in order enhance the overall performance.

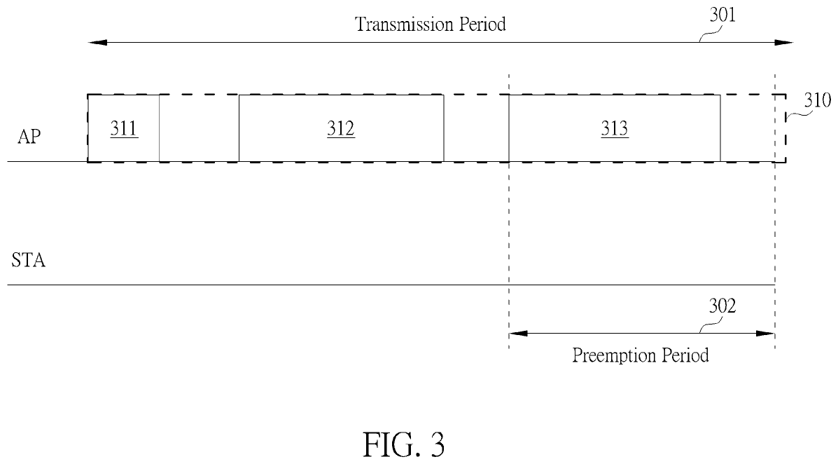

FIG. 3 illustrates a target client control scheme of the method for performing preemption management in the wireless communication system according to an embodiment of the present invention. The method can be applied to the wireless transceiver device #m such as the AP device 110 and another wireless transceiver device #m′ such as the non-AP STA device 120 (respectively labeled “AP” and “STA” for brevity) among the multiple wireless transceiver devices #1 . . . and #M for performing the preemption management in the wireless communication system 100, and the associated operations of the wireless communication system 100 operating according to the method may comprise:
(1) the AP device 110 (or the communication control circuit 114 therein) may perform a preemption client indication 311 in at least one transmission behavior (e.g., one or more transmission behaviors), which may be collectively referred to as the transmission behavior 310, at the beginning of a transmission period 301, for indicating that the non-AP STA device 120 is a preemption client which should keep awake in a preemption period 302 within the transmission period 301, where the preemption period 302 may be reserved for latency sensitive traffic transmission to the non-AP STA device 120;
(2) the non-AP STA device 120 (or the communication control circuit 124 therein) may receive the preemption client indication 311 in the aforementioned at least one transmission such as the behavior the transmission behavior 310 at the beginning of the transmission period 301, for indicating that the non-AP STA device 120 is the aforementioned preemption client which should keep awake in the preemption period 302;
(3) in response to receiving the preemption client indication 311, the non-AP STA device 120 (or the communication control circuit 124 therein) may keep awake in the preemption period 302 and be prepared for any DL traffic or any UL trigger; and
(4) the AP device 110 (or the communication control circuit 114 therein) may perform the latency sensitive traffic transmission in the preemption period 302;
where the preemption client indication may comprise a preemption client ID, for indicating the non-AP STA device 120 as the preemption client, and more particularly, further comprise one or a combination of a preemption client RU indicator indicating at least one RU for the latency sensitive traffic transmission and channel bandwidth information for the latency sensitive traffic transmission. For example, the preemption client ID may be implemented as any ID among an AID and an ID that is different from the AID (e.g., a shorter ID (SID) which is shorter than the AID). In addition, the preemption client indication 311 may comprise a candidate preemption client list for recording at least one candidate preemption client (e.g., one or more candidate preemption clients) suitable for the latency sensitive traffic transmission, and the aforementioned at least one candidate preemption client may comprise the non-AP STA device 120, but the present invention is not limited thereto. No matter whether the transmission behavior 310 represents a single transmission behavior (e.g., a single communication frame) or multiple transmission behaviors (e.g., multiple communication frames), the AP device 110 may transmit the preemption client indication 311 carrying a candidate preemption client list at the beginning of the transmission period 301, for indicating the aforementioned at least one candidate preemption client comprising the non-AP STA device 120, to make the aforementioned at least one candidate preemption client keep awake in the preemption period 302 and be prepared for any DL traffic or any UL trigger. For example, in any case among a first case of the single transmission behavior and a second case of the multiple transmission behaviors, a part 313 of the transmission behavior 310 may be arranged to carry DL data for being transmitted to the non-AP STA device 120 in the preemption period 302, and another part 312 of the transmission behavior 310 may be arranged to carry DL data for being transmitted to another non-AP STA device before the preemption period 302.

TABLE 1

| Preemption Client ID | RU |
|---|---|
| ID(STA(N1)) | RU(1) |
| ID(STA(N2)) | RU(2) |
| . . . | . . . |

Table 1 illustrates an example of the candidate preemption client list, where the candidate preemption client list may comprise the preemption client ID(s) of the candidate preemption client(s) (e.g., the STA(s) {STA(N)}), such as the preemption client IDs {ID (STA(N1)), ID (STA(N2)), . . . } of the STAs {STA(N1)), STA(N2), . . . }, as well as the preemption client RU indicators {RU(1), RU(2), . . . } indicating the RUs for the latency sensitive traffic transmission to the STAs {STA(N1)), STA(N2), . . . }, respectively, and the symbol “ . . . ” may indicate that some table contents may be omitted, but the present invention is not limited thereto. In some examples, the candidate preemption client list, the format thereof, the table contents and/or the number of the candidate preemption client(s) may vary.

TABLE 2

| Preemption Client ID | RU |
|---|---|
| ID(STA(N1)) | RU(0) |
| ID(STA(N2)) | |
| . . . | |

Table 2 illustrates another example of the candidate preemption client list, where the candidate preemption client list may comprise the preemption client ID(s) of the candidate preemption client(s) (e.g., the STA(s) {STA(N)}), such as the preemption client IDs {ID (STA(N1)), ID (STA(N2)), . . . } of the STAs {STA(N1)), STA(N2), . . . }, as well as the preemption client RU indicator RU(0) indicating a common RU for the latency sensitive traffic transmission to any STA STA(N) among the STAs {STA(N1)), STA(N2), . . . }, and the symbol “ . . . ” may indicate that some table contents may be omitted, but the present invention is not limited thereto. In some examples, the candidate preemption client list, the format thereof, the table contents and/or the number of the candidate preemption client(s) may vary.

The preemption management is applicable to at least a PPDU level, for reserving the preemption period 302 for the latency sensitive traffic transmission during the transmission of a PPDU, but the present invention is not limited thereto. For example, the preemption management is applicable to at least a TXOP level, for reserving the preemption period 302 for the latency sensitive traffic transmission during a TXOP. Regarding the TXOP level, the transmission period 302 may be a period corresponding to the TXOP, and the preemption client indication 311 may be carried in an initial control frame (ICF) among the aforementioned at least one transmission behavior such as the transmission behavior 310. In some examples, the preemption management is applicable to any level among the PPDU level and the TXOP level. If the aforementioned any level represents the PPDU level, the transmission period 302 may be a period corresponding to the PPDU, and the preemption client indication 311 may be carried in at least one field among the aforementioned at least one transmission behavior such as the transmission behavior 310 (e.g., at least one PPDU of multiple PPDUs, the multiple PPDUs comprising the PPDU and any other PPDU). If the aforementioned any level represents the TXOP level, the transmission period 302 may be the period corresponding to the TXOP, and the preemption client indication 311 may be carried in the ICF among the aforementioned at least one transmission behavior such as the transmission behavior 310.

According to some embodiments, The AP device 110 may operate according to a cross-link waking-up indication control scheme of the method to perform the preemption with the aid of a cross-link waking-up indication. For example, the AP device 110 and the non-AP STA device 120 may be implemented as multi-link devices (MLDs), and therefore may also be referred to as the AP MLD 110 and the non-AP STA MLD 120, respectively, where the AP MLD 110 may be configured to have multiple APs affiliated with the AP MLD 110, with the multiple APs being capable of co-working closely to utilize multiple wireless media efficiently and to increase transmission/reception diversity. More particularly, the communication control circuit 114 may comprise multiple communication control circuits (e.g., two or more communication control circuits acting as two or more APs) for communicating with the non-AP STA MLD 120 via multiple links (e.g., two or more links) respectively corresponding to multiple predetermined radio frequency (RF) bands (e.g., two or more predetermined RF bands) such as the 2.4 gigahertz (GHz) band, the 5 GHz band and the 6 GHz band, and the communication control circuit 124 may comprise multiple communication control circuits (e.g., two or more communication control circuits acting as two or more STAs) for communicating with the AP MLD 110 via the multiple links (e.g., the two or more links) respectively corresponding to the multiple predetermined RF bands (e.g., the two or more predetermined RF bands) such as the 2.4 GHz band, the 5 GHz band and the 6 GHz band. When a multi-link operation (MLO) device such as the AP MLD 110 is transmitting a long TX time PPDU to Client 1 on Link 1 and meanwhile some latency sensitive traffic arrives for Client 2, the MLO device such as the AP MLD 110 may send an indication to Client 2 on another link such as Link 2, to wake up Client 2 on Link 1. For example, Client 2 may be in the PS mode because the PPDU is targeting to Client 1, but the PPDU may be preempted to transmit the latency sensitive traffic for Client 2. This indication needs to be sent in time to Client 2 to wake up for receiving any potential DL data transmitted during the preemption in Link 1.

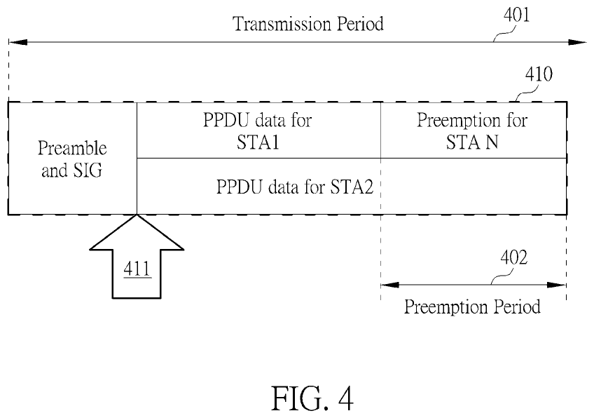

FIG. 4 illustrates a PPDU-level control scheme of the method according to an embodiment of the present invention. The transmission period 401 and the preemption period 402 can be taken as examples of the transmission period 301 and the preemption period 302 shown in FIG. 3, respectively, and the PPDU 410 and the preemption client indication 411 can be taken as examples of the transmission behavior 310 and the preemption client indication 311 mentioned above, respectively, where the transmission period 401 may be the period corresponding to the PPDU 410, and the preemption client indication 411 may be carried in at least one field (e.g., the field(s) “Preamble and SIG”) within the PPDU 410. In comparison with the PPDU 210A lacking for a preemption client indication such as that mentioned above, the PPDU 410 comprises the preemption client indication 411 at the beginning of the transmission period 401, for indicating the aforementioned at least one candidate preemption client such as the non-AP STA device 120, to make the candidate preemption client(s) keep awake in the preemption period 402 and be prepared for any DL traffic or any UL trigger.

As shown in FIG. 4, the field(s) “Preamble and SIG” may be arranged to carry the preemption client indication 411 such as the AID (or the SID) of the STA N. The STA N may enter the PS mode after decoding the SIG in the field(s) “Preamble and SIG” but awakes during the preemption period 402. For brevity, similar descriptions for this embodiment are not repeated in detail here.

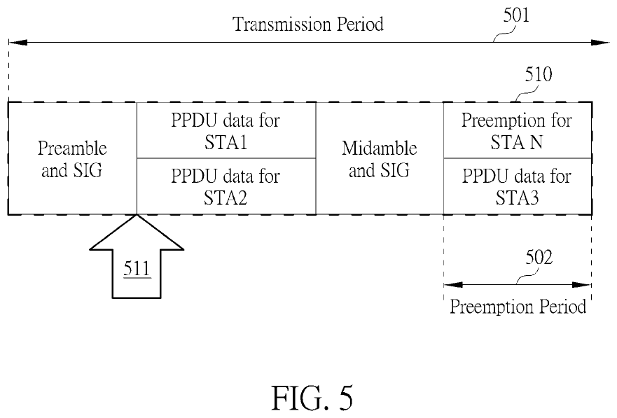

FIG. 5 illustrates the PPDU-level control scheme of the method according to another embodiment of the present invention. The transmission period 501 and the preemption period 502 can be taken as examples of the transmission period 301 and the preemption period 302 shown in FIG. 3, respectively, and the PPDU 510 and the preemption client indication 511 can be taken as examples of the transmission behavior 310 and the preemption client indication 311 mentioned above, respectively, where the transmission period 501 may be the period corresponding to the PPDU 510, and the preemption client indication 511 may be carried in at least one field (e.g., the field(s) “Preamble and SIG”) within the PPDU 510. In comparison with the PPDU 210B lacking for a preemption client indication such as that mentioned above, the PPDU 510 comprises the preemption client indication 511 at the beginning of the transmission period 501, for indicating the aforementioned at least one candidate preemption client such as the non-AP STA device 120, to make the candidate preemption client(s) keep awake in the preemption period 502 and be prepared for any DL traffic or any UL trigger.

As shown in FIG. 5, the field(s) “Preamble and SIG” may be arranged to carry the preemption client indication 511 such as the AID (or the SID) of the STA N. The STA N may enter the PS mode after decoding the SIG in the field(s) “Preamble and SIG” but awakes before the Midamble (or before the field(s) “Midamble and SIG”). If the preemption is not for the STA N, the STA N may enter the PS mode after decoding the Midamble and SIG until the end of the PPDU 510. For brevity, similar descriptions for this embodiment are not repeated in detail here.

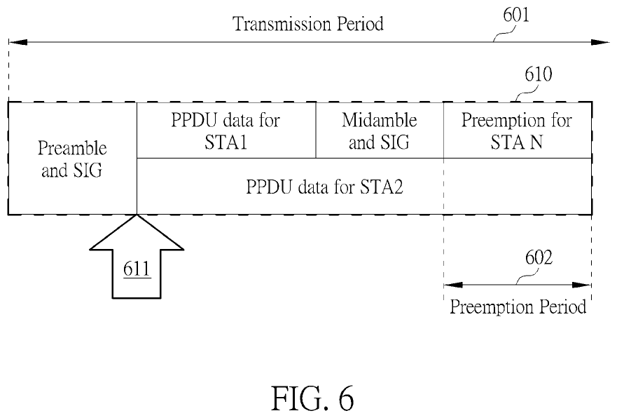

FIG. 6 illustrates the PPDU-level control scheme of the method according to yet another embodiment of the present invention. The transmission period 601 and the preemption period 602 can be taken as examples of the transmission period 301 and the preemption period 302 shown in FIG. 3, respectively, and the PPDU 610 and the preemption client indication 611 can be taken as examples of the transmission behavior 310 and the preemption client indication 311 mentioned above, respectively, where the transmission period 601 may be the period corresponding to the PPDU 610, and the preemption client indication 611 may be carried in at least one field (e.g., the field(s) “Preamble and SIG”) within the PPDU 610. In comparison with the PPDU 210C lacking for a preemption client indication such as that mentioned above, the PPDU 610 comprises the preemption client indication 611 at the beginning of the transmission period 601, for indicating the aforementioned at least one candidate preemption client such as the non-AP STA device 120, to make the candidate preemption client(s) keep awake in the preemption period 602 and be prepared for any DL traffic or any UL trigger.

As shown in FIG. 6, the field(s) “Preamble and SIG” may be arranged to carry the preemption client indication 611 such as the AID (or the SID) of the STA N. The STA N may enter the PS mode after decoding the SIG in the field(s) “Preamble and SIG” but awakes before the Midamble (or before the field(s) “Midamble and SIG”). If the preemption is not for the STA N, the STA N may enter the PS mode after decoding the Midamble and SIG until the end of the PPDU 610. For brevity, similar descriptions for this embodiment are not repeated in detail here.

Based on the PPDU-level control scheme, there is an additional indicator (e.g., the preemption client indication 311, such as any preemption client indication among the preemption client indication 411, 511 and 611) in the field(s) “Preamble and SIG” of the PPDU (e.g., any PPDU among the PPDUs 410, 510 and 610) to announce and/or forecast the aforementioned at least one candidate preemption client (e.g., the one or more candidate preemption clients) such as the potential clients to receive DL data during the preemption. These clients may be in the PS mode until the preemption portion, but the present invention is not limited thereto. When there is a need, one or more clients among these clients may not be allocated for DL during the preemption, for example, in a situation where the traffic for the client may not come or where the resource may not be enough for all potential clients. In addition, the indication can be separated from indications of clients to receive DL data immediately after the SIG in the field(s) “Preamble and SIG” of the PPDU. If there is the field(s) “Midamble and SIG” before the preemption, accurate resource allocation of preemption can be announced in the Midamble and SIG by the AP device 110.

Some implementation details regarding how the AP device 110 determines and/or picks up the aforementioned at least one candidate preemption client (e.g., the one or more candidate preemption clients) such as the potential clients in the Preamble and SIG may be further described as follows. In addition to the target client control scheme, the PPDU-level control scheme, etc., the aforementioned at least one control scheme of the method may further comprise a registration control scheme as to the registration of the non-AP STA device 120 (or the client), as well as an announcement-request control scheme as to the announcement and/or request from the AP device 110 to the non-AP STA device 120 (or the client).

Based on the registration control scheme, before the transmission period 301 (e.g., any transmission period among the transmission periods 401, 501 and 601), the AP device 110 may perform preemption client registration for the non-AP STA device 120, in order to add the non-AP STA device 120 as a member of the aforementioned at least one candidate preemption client into the candidate preemption client list. For example, the AP device 110 may perform the preemption client registration in response to a request from the non-AP STA device 120. In another example, the AP device 110 may perform the preemption client registration in response to a Stream Classification Service (SCS) procedure that is set up by the non-AP STA device 120 with the AP device 110. More particularly, the non-AP STA device 120 acting as the client can send a frame to the AP device 110, with the frame carrying the request to be included in the forecast in the Preamble and SIG for the potential DL preemption. The request can indicate which TID(s) are included for the preemption. The AP device 110 may reject or accept the request with a response frame. The non-AP STA device 120 acting as the client can cancel the request by sending another frame to request the cancellation. In addition, the request may be implicitly set up while the non-AP STA device 120 acting as the client has set up the SCS procedure with the AP device 110 (or the AP MLD 110), for example, including Extremely High Throughput (EHT) SCS, Mirrored Stream Classification Service (MSCS) procedures for a specific TID, UL or DL, and any other SCS based procedures. This implicit setup can be automatically cancelled while the SCS procedure is ended. The client can request not to be included in the potential DL preemption (or the candidate preemption client list) even it has set up an SCS procedure with sending an additional request frame to the AP device 110. Additionally, the preemption client ID such as the AID may have 12 bits. In order to save the preemption client ID length (i.e., the length of the preemption client ID) such as the AID length (i.e., the length of the AID), the AP device 110 may assign a shorter ID (SID) such as that mentioned above (e.g. the SID with 6 bits) to the non-AP STA device 120 and uses the SID in the SIG for indication.

Based on the announcement-request control scheme, before the transmission period 301 (e.g., any transmission period among the transmission periods 401, 501 and 601), the AP device 110 may determine to add the non-AP STA device 120 as the member of the aforementioned at least one candidate preemption client into the candidate preemption client list, and notify the non-AP STA device 120 of the determination with a first frame. For example, the first frame may be arranged to indicate one or more traffic identifiers (TIDs) that are included for the preemption management. The AP device 110 may send the first frame as a request (or an announcement) of adding the non-AP STA device 120 into the candidate preemption client list, to allow the non-AP STA device 120 to selectively accept the determination of the AP device 110, where the non-AP STA device 120 may determine whether to accept (or reject) the request. When there is a need, the AP device 110 may selectively cancel the determination of the AP device 110, and notify the non-AP STA device 120 of the cancellation with a second frame. More particularly, the AP device 110 may decide to include a client to the potential DL preemption (or the candidate preemption client list) while any condition among the following conditions is met:
(1) the non-AP STA device 120 acting as the client has an ongoing low latency DL traffic, for example, the ongoing low latency DL traffic may comprise any traffic corresponding to any TID among the TIDs of AC_VO (or Access Category of Voice) and AC_VI (or Access Category of Video);
(2) the non-AP STA device 120 acting as the client has any negotiation of TID-to-Link mapping of specific TIDs for DL transmission; and
(3) there are any other reason(s) to improve the DL Quality of Service (QOS) of the client. In addition, the AP device 110 may use the first frame to inform and/or request the non-AP STA device 120 acting as the client that the client has been included in the potential DL preemption (or the candidate preemption client list). The request can indicate which TID(s) or all TIDs are included for the preemption. The non-AP STA device 120 acting as the client may accept or reject the request by a response frame, for example, the non-AP STA device 120 acting as the client may have higher priority to perform power saving. If there is no longer latency sensitive traffic for the client, the request can be cancelled afterward. For example, the AP device 110 may send at least one other frame (e.g., one or more other frames) with optional TID information to the non-AP STA device 120 acting as the client to cancel the preemption for those TIDs or all TIDs. According to some embodiments, in order to save the preemption client ID length such as the AID length, the AP device 110 may assign a shorter ID (SID) such as that mentioned above (e.g. the SID with 6 bits) to the non-AP STA device 120 and uses the SID in the SIG for indication, but the present invention is not limited thereto.

No matter whether the aforementioned any level represents the PPDU level or the TXOP level, in any case among the first case of the single transmission behavior and the second case of the multiple transmission behaviors, the AP device 110 may prepare the preemption client indication 311 carrying the candidate preemption client list for indicating the aforementioned at least one candidate preemption client such as the one or more candidate preemption clients, including the non-AP STA device 120, and transmit the preemption client indication 311 to make the candidate preemption clients keep awake in the preemption period 302 and be prepared for any DL traffic or any UL trigger. More particularly, the AP device 110 owns and maintains a total preemption client list regarding the registration control scheme and/or the announcement-request control scheme, such as a list of clients which have registered (or being requested) the DL preemption. The AP device 110 AP can select a subset of the list to be included in the candidate preemption client list (e.g., the candidate preemption client list carried by the Preamble and SIG of the PPDU, in a situation where the aforementioned any level represents the PPDU level) to make the preemption client indication 311, the preemption client indication 311 comprising the subset or the selected client(s) including the non-AP STA device 120 (or the STA N), so that those client(s) can be ready for the preemption DL transmission in the preemption period 302. Under control of the AP device 110, the preemption client indication 311 can be dynamically changed per transmission period among various transmission periods 301 based on the loading and DL traffic conditions. For short transmission periods among various transmission periods 301, the AP device 110 may not need to include such indication, the preemption client indication 311, in order to save some overhead. Taking the PPDU level as an example, the preemption client indication 311 can be dynamically changed per PPDU based on the loading and DL traffic conditions, and for short PPDUs, the AP device 110 may not need to include such indication to save some overhead, but the present invention is not limited thereto. In some examples, if there is a Midamble and SIG before the preemption, the clients to have DL data after the Midamble and SIG are announced in the Midamble and SIG and can be selected from any of the following:
(1) the clients in the preemption client indication 311 in the Preamble and SIG of the PPDU; and
(2) the clients all in the Preamble and SIG of the PPDU, including the clients in the preemption client indication 311 as well as the clients outside the preemption client indication 311 within the Preamble and SIG of the PPDU.

In the AP device 110, any communication control circuit among the aforementioned at least one communication control circuit such as the communication control circuit 114 may comprise a PHY circuit and a MAC circuit for performing PHY and MAC layer operations, respectively. The AP device 110 may determine whether the DL data for any client(s) among the clients in the preemption client indication 311 in the Preamble and SIG of the PPDU arrives in the MAC circuit during a time interval between the Preamble/SIG and the Preamble/SIG (e.g., any time interval between the Preamble or the SIG of the field(s) “Preamble and SIG” and the Midamble or the SIG of the Preamble or the SIG of the field(s) “Midamble and SIG”) and is ready for being transmitted by the PHY circuit, in order to dynamically determine or select the clients for being announced in the Midamble and SIG. If the DL data for these client(s) arrives in the MAC circuit during the time interval and is ready for being transmitted by the PHY circuit, the AP device 110 may select these client(s) for being announced in the Midamble and SIG. The AP device 110 may send additional notices to those clients to decode the Midamble.

According to some embodiments, considering the candidate preemption client list such as the STA list regarding the candidate preemption client(s) such as the STA(s) (e.g., the STA N), another way to ensure the PPDU preemption (if data is allocated) can be correctly received is to regulate those STAs' behavior after receiving the Preamble and SIG, even though in the Preamble and SIG, those STAs are not indicated. For example, the AP device 110 may be arranged to force the candidate preemption client(s) such as those STAs to be always ready to receive the data in the preemption or the Midamble and SIG with full RX capabilities (e.g. multiple spatial stream (SS) receiving), but the present invention is not limited thereto. In more efficient way, the AP device 110 and the candidate preemption client(s) may be arranged to operate with intra-PPDU spatial multiplexing power save (SMPS), where the candidate preemption client(s) such as those STAs remain one spatial stream activated and therefore keep being capable of receiving the Midamble and SIG of the PPDU, and need to resume to the original RX spatial stream capabilities if the preemption is to carry data for them. In some examples, the candidate preemption client(s) such as those STAs may be arranged to operate with any SMPS among the intra-PPDU SMPS corresponding to the PPDU level and the intra-TXOP SMPS corresponding to the TXOP level, depending on whether the aforementioned any level represents the PPDU level or the TXOP level, to remain one spatial stream activated for receiving a subsequent indication (e.g., the subsequent indication in the Midamble and SIG) coming after the preemption client indication.

As the aforementioned at least one candidate preemption client (or “the candidate preemption client(s)”) may comprise the non-AP STA device 120, when the candidate preemption client(s) such as those STAs operate with the aforementioned any SMPS among the intra-PPDU SMPS and the intra-TXOP SMPS, the non-AP STA device 120 that has been added as the member of the candidate preemption client(s) into the candidate preemption client list may also operate with the aforementioned any SMPS among the intra-PPDU SMPS and the intra-TXOP SMPS, to remain one spatial stream activated for receiving the subsequent indication coming after the preemption client indication. In response to the subsequent indication indicating that the AP device 110 is going to transmit to the non-AP STA device 120, the non-AP STA device 120 may resume to the original RX spatial stream capability thereof to make multiple spatial streams be activated for receiving data (e.g., latency sensitive data) from the AP device 110. In addition, the preemption management is applicable to the aforementioned any level among the PPDU level and the TXOP level. If the aforementioned any level represents the PPDU level, the transmission period 302 may be the period corresponding to the PPDU, and the AP device 110 and the candidate preemption client(s) such as the non-AP STA device 120 may be arranged to operate with the intra-PPDU SMPS, where the non-AP STA device 120 remains one spatial stream activated for receiving the subsequent indication coming after the preemption client indication, such as the subsequent indication within the PPDU, and in response to the subsequent indication, the non-AP STA device 120 makes the multiple spatial streams be activated for receiving the latency sensitive data from the AP device 110, but the present invention is not limited thereto. If the aforementioned any level represents the TXOP level, the transmission period 302 may be the period corresponding to the TXOP, and the AP device 110 and the candidate preemption client(s) such as the non-AP STA device 120 may be arranged to operate with the intra-TXOP SMPS, where the non-AP STA device 120 remains one spatial stream activated for receiving the subsequent indication coming after the preemption client indication, such as the subsequent indication within the TXOP, and in response to the subsequent indication, the non-AP STA device 120 makes the multiple spatial streams be activated for receiving the latency sensitive data from the AP device 110.

According to some embodiments, no matter whether the aforementioned any level represents the PPDU level or the TXOP level, it is suggested that a client may be included in the DL preemption (or the candidate preemption client list) only during a specific (service) period, for example, during a target wake time (TWT) service period (SP) or during a period specified by the client in the request frame, but the present invention is not limited thereto. More particularly, for the latter case among these two cases, the request frame carries timing synchronization function (TSF) information of starting instant and ending instant, and carries a count of beacon intervals to indicate when the period ends. For brevity, similar descriptions for these embodiments are not repeated in detail here.

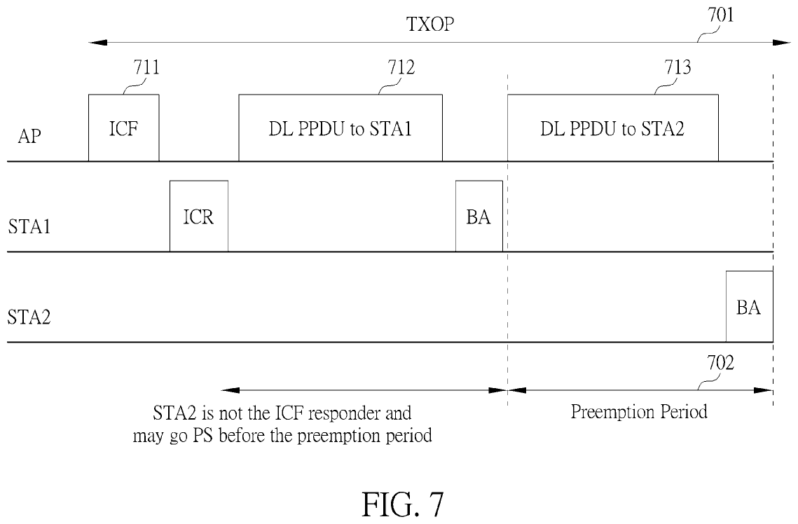

FIG. 7 illustrates a TXOP-level control scheme of the method according to an embodiment of the present invention. The transmission period 701 and the preemption period 702 can be taken as examples of the transmission period 301 and the preemption period 302 shown in FIG. 3, respectively, and the frames from the AP device 110 (labeled “AP” for brevity), such as the ICF 711 and the DL PPDUs 712 and 713 to the STAs STA1 and STA2 (labeled “DL PPDU to STA1” and “DL PPDU to STA2” for brevity) can be taken as examples of the aforementioned at least one transmission behavior (or the transmission behavior 310), where the transmission period 702 may be the period corresponding to the TXOP, and the preemption client indication 311 may be carried in the ICF 711. When receiving the ICF 711 (e.g., a request to send (RTS)), the STA STA1 may replay with an ICF response (ICR) (e.g., a clear to send (CTS)) and start receiving the DL PPDU 712, and send a block acknowledgment (BA) after completing receiving the DL PPDU 712.

Regarding the TXOP preemption usage in the TXOP-level control scheme, the candidate preemption client list such as the STA list of the PPDU preemption can also be used as the STA list of the TXOP preemption so that those STA can awake during the preemption period 702 of the TXOP. If the non-AP STA device 120 such as the STA STA2 receives the ICF 711 from the AP device 110 not addressing to it, it may go to (or enter) the PS mode until the network allocation vector (NAV) set up by the ICF 711 ends, before the preemption period 702 (labeled “STA2 is not the ICF responder and may go PS before the preemption period” for brevity), but the present invention is not limited thereto. For example, the non-AP STA device 120 such as the STA STA2 can keep listening to the channel and wait for the channel using enhanced distributed channel access (EDCA). In addition, if the AP device 110 acting as the TXOP holder announces a potential preemption period such as the preemption period 702 during the TXOP (or during the transmission period 701) in advance or in a way before the preemption period 702, the candidate preemption client(s) such as the STA(s) in the candidate preemption client list, including the non-AP STA device 120 such as the STA STA2, need to awake during this preemption period 702 and to be prepared for any possible DL traffic or any UL trigger. For brevity, similar descriptions for this embodiment are not repeated in detail here.

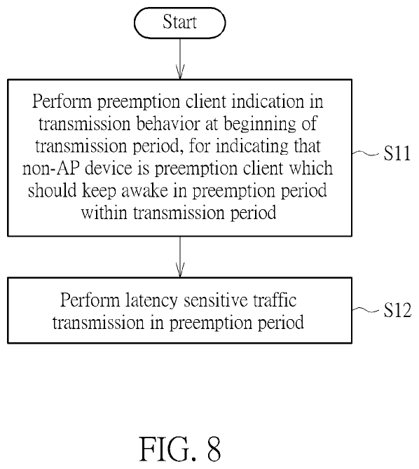

FIG. 8 illustrates a working flow of the method according to an embodiment of the present invention. The wireless transceiver device #m such as the AP device 110 and the other wireless transceiver device #m′ such as the non-AP STA device 120 may operate according to the working flow shown in FIG. 8, but the present invention is not limited thereto.

In Step S11, the AP device 110 (or the communication control circuit 114) may perform the preemption client indication 311 in the aforementioned at least one transmission behavior such as the transmission behavior 310 at the beginning of the transmission period 301, for indicating that the non-AP STA device 120 is the preemption client which should keep awake in the preemption period 302 within the transmission period 301, where the preemption period 302 may be reserved for the latency sensitive traffic transmission to the non-AP STA device 120. For example, when the preemption management is applied to the PPDU level, the transmission period 301 and the preemption period 302 may represent the transmission period 401 and the preemption period 402 shown in FIG. 4 (or the transmission period 501 and the preemption period 502 shown in FIG. 5, or the transmission period 601 and the preemption period 602 shown in FIG. 6), respectively.

In another example, when the preemption management is applied to the TXOP level, the transmission period 301 and the preemption period 302 may represent the transmission period 701 (e.g., the period corresponding to the TXOP) and the preemption period 702 shown in FIG. 7, respectively.

In Step S12, the AP device 110 (or the communication control circuit 114) may perform the latency sensitive traffic transmission in the preemption period 302. For example, as the preemption client indication 311 may comprise the candidate preemption client list for recording the aforementioned at least one candidate preemption client suitable for the latency sensitive traffic transmission, the non-AP STA device 120 may keep awake in the preemption period 302 and be ready for receiving the latency sensitive traffic of the latency sensitive traffic transmission in the preemption period 302. For brevity, similar descriptions for this embodiment are not repeated in detail here.

For better comprehension, the method may be illustrated with the working flow shown in FIG. 8, but the present invention is not limited thereto. According to some embodiments, one or more steps may be added, deleted, or changed in the working flow shown in FIG. 8. For example, the non-AP STA device 120 (or the communication control circuit 124) may receive the preemption client indication 311 in the aforementioned at least one transmission such as the behavior the transmission behavior 310 at the beginning of the transmission period 301, for indicating that the non-AP STA device 120 is the preemption client which should keep awake in the preemption period 302, and in response to receiving the preemption client indication 311, the non-AP STA device 120 (or the communication control circuit 124) may keep awake in the preemption period 302 and be prepared for any DL traffic or any UL trigger. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing preemption management in a wireless communication system, wherein a non-access-point station (non-AP STA) device is wirelessly linking to a first access point (AP) device, the method comprising:
performing, by the first AP device, a preemption client indication in at least one transmission behavior at beginning of a transmission period, for indicating that the non-AP STA device is a preemption client which should keep awake in a preemption period within the transmission period;
wherein the preemption period is reserved for latency sensitive traffic transmission to the non-AP STA device.

2. The method of claim 1, further comprising:
performing the latency sensitive traffic transmission, by the first AP device, in the preemption period.

3. The method of claim 1, wherein the preemption management is applicable to at least a transmission opportunity (TXOP) level, for reserving the preemption period for the latency sensitive traffic transmission during a TXOP.

4. The method of claim 3, wherein regarding the TXOP level, the transmission period is a period corresponding to the TXOP, and the preemption client indication is carried in an initial control frame (ICF) among the at least one transmission behavior.

5. The method of claim 1, wherein the preemption management is applicable to at least a physical layer (PHY) protocol data unit (PPDU) level, for reserving the preemption period for the latency sensitive traffic transmission during transmission of a PPDU.

6. The method of claim 1, wherein the preemption client indication comprises a candidate preemption client list for recording at least one candidate preemption client suitable for the latency sensitive traffic transmission, wherein the at least one candidate preemption client comprises the non-AP STA device.

7. The method of claim 6, wherein before the transmission period, the first AP device is arranged to perform preemption client registration for the non-AP STA device, in order to add the non-AP STA device as a member of the at least one candidate preemption client into the candidate preemption client list.

8. The method of claim 7, wherein the first AP device is arranged to perform the preemption client registration in response to a request from the non-AP STA device.

9. The method of claim 7, wherein the first AP device is arranged to perform the preemption client registration in response to a stream classification service (SCS) procedure that is set up by the non-AP STA device with the first AP device.

10. The method of claim 6, wherein before the transmission period, the first AP device is arranged to determine to add the non-AP STA device as a member of the at least one candidate preemption client into the candidate preemption client list, and notify the non-AP STA device of the determination with a first frame.

11. The method of claim 10, wherein the first frame is arranged to indicate one or more traffic identifiers (TIDs) that are included for the preemption management.

12. The method of claim 10, wherein the first AP device is arranged to send the first frame as a request or an announcement of adding the non-AP STA device into the candidate preemption client list, to allow the non-AP STA device to selectively accept the determination of the first AP device.

13. The method of claim 10, wherein the first AP device is arranged to selectively cancel the determination, and notify the non-AP STA device of the cancellation with a second frame.

14. The method of claim 1, wherein the preemption client indication comprises a preemption client identifier (ID), indicating the non-AP STA device as the preemption client.

15. The method of claim 14, wherein the preemption client ID is implemented as any ID among an association ID (AID) and an ID that is different from the AID.

16. The method of claim 14, wherein the preemption client indication further comprises one or a combination of a preemption client resource unit (RU) indicator indicating at least one RU for the latency sensitive traffic transmission and channel bandwidth information for the latency sensitive traffic transmission.

17. The method of claim 1, wherein the first AP device is arranged to transmit the preemption client indication carrying a candidate preemption client list, indicating at least one candidate preemption client comprising the non-AP STA device, to make the at least one candidate preemption client keep awake in the preemption period and be prepared for any downlink (DL) traffic or any uplink (UL) trigger.

18. The method of claim 17, wherein the at least one candidate preemption client is arranged to operate with any spatial multiplexing power save (SMPS) among intra-TXOP SMPS and intra-PPDU SMPS, to remain one spatial stream activated for receiving a subsequent indication coming after the preemption client indication; and in response to the subsequent indication indicating that the first AP device is going to transmit to the non-AP STA device, the non-AP STA device is arranged to resume to an original reception (RX) spatial stream capability to make multiple spatial streams be activated for receiving data from the first AP device.

19. An access point (AP) device, for performing preemption management in a wireless communication system, the AP device comprising:
a processing circuit, arranged to control operations of the AP device; and
at least one communication control circuit, coupled to the processing circuit, arranged to perform communication control, wherein the at least one communication control circuit is arranged to perform wireless communication operations with at least one other device within the wireless communication system for the AP device, wherein a non-access-point station (non-AP STA) device among the at least one other device is wirelessly linking to the AP device;
wherein:
the AP device is arranged to perform a preemption client indication in at least one transmission behavior at beginning of a transmission period, for indicating that the non-AP STA device is a preemption client which should keep awake in a preemption period within the transmission period; and
the preemption period is reserved for latency sensitive traffic transmission to the non-AP STA device.

20. A non-access-point station (non-AP STA) device, for performing preemption management in a wireless communication system, the non-AP STA device comprising:
a processing circuit, arranged to control operations of the non-AP STA device; and
at least one communication control circuit, coupled to the processing circuit, arranged to perform communication control, wherein the at least one communication control circuit is arranged to perform wireless communication operations with at least one other device within the wireless communication system for the non-AP STA device, wherein the non-AP STA device is wirelessly linking to a first access point (AP) device among the at least one other device;
wherein:
the non-AP STA device is arranged to receive a preemption client indication in at least one transmission behavior at beginning of a transmission period, for indicating that the non-AP STA device is a preemption client which should keep awake in a preemption period within the transmission period, wherein the preemption period is reserved for latency sensitive traffic transmission to the non-AP STA device; and
in response to receiving the preemption client indication, the non-AP STA device is arranged to keep awake in the preemption period and be prepared for any downlink (DL) traffic or any uplink (UL) trigger.

21. The non-AP STA device of claim 20, wherein the non-AP STA device is arranged to operate with any spatial multiplexing power save (SMPS) among intra-TXOP SMPS and intra-PPDU SMPS, to remain one spatial stream activated for receiving a subsequent indication coming after the preemption client indication; and in response to the subsequent indication indicating that the first AP device is going to transmit to the non-AP STA device, the non-AP STA device is arranged to resume to an original reception (RX) spatial stream capability to make multiple spatial streams be activated for receiving data from the first AP device.
